(19) United States
(12) Patent Application Publication
(10) Pub. No.: US 2013/0204824 A1
(43) Pub. Date: Aug. 8, 2013

(54) System and Method to Uplink Data to the Flight Deck of an Aircraft

(71) Applicant: PASSUR Aerospace, Inc., Stamford, CT (US)

(72) Inventors: James BARRY, Madison, CT (US); Tim Cinello, Tampa, FL (US); Ron Dunsky, Brooklyn, NY (US); Chris Maccarone, Eagan, MN (US); Thomas O'Halloran, Gaylordsville, CT (US); Thomas White, Huntington, NY (US)

(73) Assignee: PASSUR Aerospace, Inc., Stamford, CT (US)

(21) Appl. No.: 13/731,396

(22) Filed: Dec. 31, 2012

Related U.S. Application Data
(60) Provisional application No. 61/581,403, filed on Dec. 29, 2011.

(51) Int. Cl. G06N 5/02

(52) U.S. Cl. CPC G06N 5/022
USPC 706/46

(57) ABSTRACT

A system, method and computer readable storage medium for generating predictive analysis and alert information, displaying the predictive analysis and alert information to a user on the ground, receiving, from the user, a selection of categories of the predictive analysis and alert information, formatting a message including the predictive analysis and alert information corresponding to the selected categories and transmitting the message to a flight deck of an aircraft.

### PRIORITY CLAIM/INCORPORATION BY REFERENCE

The present application claims priority to U.S. Provisional Patent Application 61/581,403 filed on Dec. 29, 2011 entitled “Data Uplink to the Flight Deck” naming James Barry, Tim Cinello, Ron Dunsky, Chris Maccarone, Thomas O'Halloran, and Thomas White as inventors, and hereby incorporates, by reference, the entire subject matter of this Provisional Application.

### BACKGROUND INFORMATION

In recent years, airline and airport personnel such as air traffic control (ATC) coordinators and dispatchers have had access to additional sources of information beyond the traditional flight information provided by the Federal Aviation Authority (FAA). An example of these additional sources of information is the suite of products offered by PASSUR Aerospace, Inc. of Stamford, Conn. The PASSUR products provide the airline and airport personnel with many different predictive analysis information and alerts that are useful in operating the airport and specific flights.

However, there is currently no system that allows this additional information to be viewed by pilots in an aircraft. The pilots are limited to receiving the traditional FAA data and the information they receive orally from flight controllers. Thus, there is a need to effectively communicate this additional information to pilots.

### SUMMARY OF THE INVENTION

A method for generating, by a server, predictive analysis and alert information, displaying the predictive analysis and alert information to a user on the ground, receiving, from the user, a selection of categories of the predictive analysis and alert information, formatting a message including the predictive analysis and alert information corresponding to the selected categories and transmitting the message to a flight deck of an aircraft.

A system having a predictive analysis and alert system that generates predictive analysis and alert information and distributes the predictive analysis and alert information to a user, a user interface that displays the predictive analysis and alert information plurality and receives, from the user, a selection of categories of the predictive analysis and alert information and an uplink module that formats a message including the predictive analysis and alert information corresponding to the selected categories and transmits the message to a flight deck of an aircraft.

A non-transitory computer readable storage medium storing a set of instructions that are executable by a processor. The instructions cause the processor to generate predictive analysis and alert information, display the predictive analysis and alert information to a user on the ground, receive, from the user, a selection of categories of the predictive analysis and alert information, format a message including the predictive analysis and alert information corresponding to the selected categories and transmit the message to a flight deck of an aircraft.

### BRIEF DESCRIPTION OF THE DRAWINGS

FIG. 1 shows an exemplary information system including a data uplink path to a flight deck of multiple aircraft according to an exemplary embodiment.

FIG. 2 shows an exemplary diversion management screen that is displayed to the users according to an exemplary embodiment.

FIG. 3 shows a table that includes examples of categories of data related to holds that may be displayed and uplinked to the flight deck according to an exemplary embodiment.

FIG. 4 shows a table that includes an example of a further selection of categories of information to be uplinked to an aircraft according to an exemplary embodiment.

FIG. 5 shows an exemplary flight deck display according to an exemplary embodiment.

FIG. 6 shows an exemplary method for uplinking data to the flight deck of an aircraft according to an exemplary embodiment.

### DETAILED DESCRIPTION

The exemplary embodiments may be further understood with reference to the following description of the exemplary embodiments and the related appended drawings, wherein like elements are provided with the same reference numerals. The exemplary embodiments are related to a system and method of providing non-traditional airport, airline and flight information to the flight deck of an aircraft. The non-traditional information includes, for example, predictive analysis and alert information.

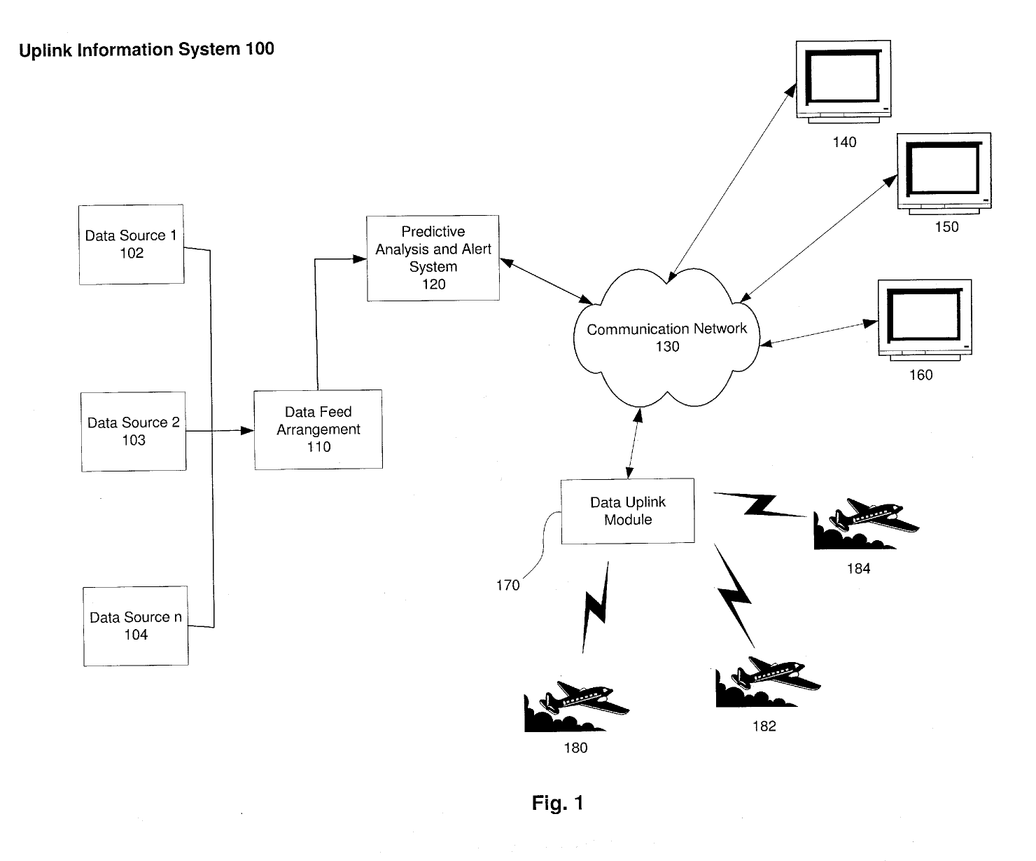

FIG. 1 shows an exemplary uplink information system 100 including a data uplink path to a flight deck of multiple aircraft. According to the system 100, a data feed arrangement 110 may obtain data, which is used to generate predictive analyses and alerts for an aircraft, airport and/or an airline. In this example, the predictive analysis and alerts will be related to diversion management for an airport. However, those skilled in the art will understand that any type of predictive analysis and alerts may be generated by the system 100. For example, the suite of products described above and available from PASSUR Aerospace, Inc. of Stamford, Conn. include predictive analysis and alerts related to surface management at an airport, tarmac delay management at an airport, departure metering, arrival management, airspace optimization, etc.

The data used by the system 100 may be received from any number of data sources (e.g., data source 1(102), data source 2 (103), data source n (104)), which may provide information regarding an aircraft in flight, airport operations, airline operations, etc. Examples of data sources include active radar systems, Secondary Surveillance Radar (“SSR”), Passive Secondary Surveillance Radar (“PSSR”), primary data sources (e.g., an Aircraft Situation Display (“ASD”) data source), and/or secondary data sources (e.g., airline schedule information, weather information sources, etc.).

The data feed arrangement 110 may be connected to a predictive analysis and alert system 120, which may include, for example, software and hardware for accomplishing the particular functionality associated with the predictive analysis and alert system 120. As described above, in this example, the functionality is a diversion management functionality. Thus, the predictive analysis and alert system 120 may include server hardware and software to perform the analysis and calculations to aid the ATC personnel in managing diversions for the airport. The software and hardware may further include a web server to distribute the information to the various users 140-160 that need access to the information via a communication network 130. Those skilled in the art will understand that other manners of distributing the information generated by the predictive analysis and alert system 120 may also be used.

In addition, the system 100 also includes a data uplink module 170 that is connected to the communications network 130. The data uplink module 170 also receives information from the predictive analysis and alert system 120 and provides this information to aircraft 180, 182, 184. As will be described in greater detail below, the data that is provided to the aircraft 180-184 is selected by one or more of the users 140-160 and is also data that is specifically directed at the aircraft of interest. For example, aircraft 180 may be a United Airlines flight, aircraft 182 may be an American Airlines flight and aircraft 184 may be a Delta Airlines flight. A particular piece of information generated by the predictive analysis and alert system 120 may only be related to United Airlines flights. Thus, the data uplink module 170 will only transmit this information to the aircraft 180.

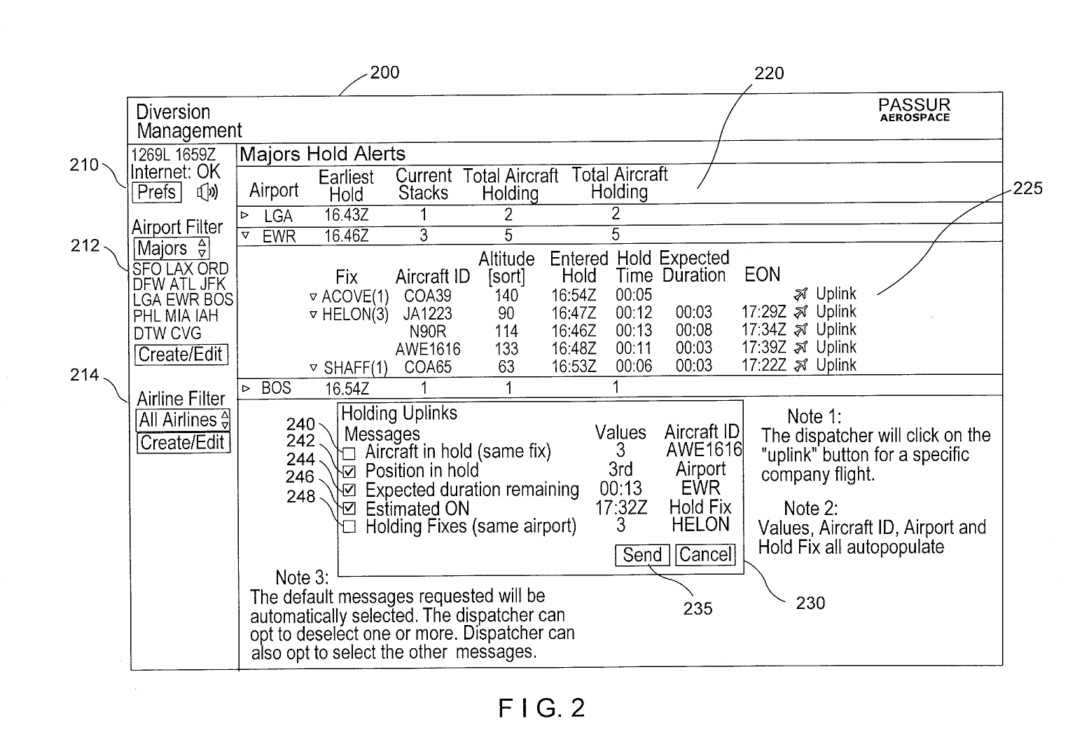

FIG. 2 shows an exemplary diversion management screen 200 that is displayed to the users 140-160. As described above, the predictive analysis and alert system 120 may be any type of system, but in this example it is a diversion management system. Thus, the diversion management screen 200 is an example of a type of screen that may be displayed to the users 140-160 in such a scenario. Referring to FIG. 1, the predictive analysis and alert system 120 generates information that is formatted by a web server into screen 200 and distributed via communications network 130 to the users 140-160.

Each of the users may view the diversion management screen 200 on their display devices and format the screen 200 according to their preferences. For example, the diversion management screen 200 includes a filtering area 210 that allows the users 140-160 to filter information by airport 212 and by airline 214. In this example, the particular user has selected the major airports as indicated by the displayed list and all airlines. Thos skilled in the art will understand that any type of filtering may be selected by the users 140-160.

The diversion management screen 200 also includes a main information area 220 that in this example shows information relating to hold alerts for aircraft. In this example, three (3) of the selected major airports include hold alerts, New York LaGuardia (LGA), Newark Liberty (EWR) and Boston Logan (BOS). In this example, the user 140-160 has determined to focus on the hold alerts for Newark Liberty airport (EWR). The diversion management screen 200 displays information for the airport that is generated by the predictive analysis and alert system 120. This information will be described, but it is noted that the information is only exemplary and other diversion related information may also be displayed and uplinked or other types of predictive analysis and alerts may be displayed and uplinked.

In this example, the diversion management screen 200 displays the earliest hold time (16:46Z), the current stacks (3), the total number of aircraft holding (5) and the filtered number of aircraft holding (5). The total and filtered number of aircraft holding is identical in this situation because the user 140-160 selected all airlines for filtering and therefore all aircraft are selected. The diversion management screen 200 further includes each of the fix points for EWR and the number of aircraft holding at these fix points, e.g., fix point ACOVE with one (1) aircraft holding, fix point HELON with three (3) aircraft holding and fix point SHAFF with one (1) aircraft holding.

The diversion management screen 200 provides additional information for each of the aircraft that is holding. For example, the third aircraft that is holding at fix point HELON is flight AWE1616 that is holding at an altitude of 133 (13,300 feet), entered the hold at 16:48Z and has been holding for 11 minutes. The expected duration of the hold is an additional 13 minutes and the estimated ON time is 17:22Z. Thus, by viewing the information on the diversion management screen 200, the users 140-160 may gain useful insight into the operation of the particular airport, which is EWR, in this example. However, as described above, it may also be useful for the pilots of these flights to have this information.

The diversion management screen 200 also includes an uplink button 225 for each of the flights displayed on the screen. The uplink button 225 allows the users 140-160 to uplink or send the information for the flight to the flight deck of the aircraft. It should be noted that each of the users 140-160 may have different levels of permissions to interact with the diversion management screen 200 and predictive analysis and alert system 120. Only those users 140-160 having the requisite permission level are allowed to uplink data to the aircraft.

When the uplink button 225 is selected for a particular flight, a dialog box 230 opens on the diversion management screen 200. The dialog box 230 auto-populates with the appropriate information for the selected flight. In this example, the user 140-160 selected the flight AWE1616 resulting in the information displayed in the dialog box 230. In this example, the information that is auto-populated is Aircraft in hold (same fix) 240, Position in hold 242, Expected duration remaining 244, Estimated On 246 and Holding Fixes (same airport) 248. As will be described in greater detail below, the categories of information that are included in the dialog box 230 may be pre-selected by the users 140-160 or a system administrator.

After the dialog box 230 is auto-populated for the selected flight and displayed to the user 140-160, the user may then deselect one or more categories of information to uplink to the flight deck. In this example, each category of information includes a checkbox. The user 140-160 may deselect a category of information by un-checking a particular category of information. In this example, the user 140-160 has deselected the categories of information Aircraft in hold (same fix) 240 and Holding Fixes (same airport) 248. When the user 140-160 is satisfied with the information that is to be uplinked to the flight deck, the user 140-160 may press the send button 235 and the information is uplinked to the flight deck of the selected aircraft, which in this example is flight AWE1616.

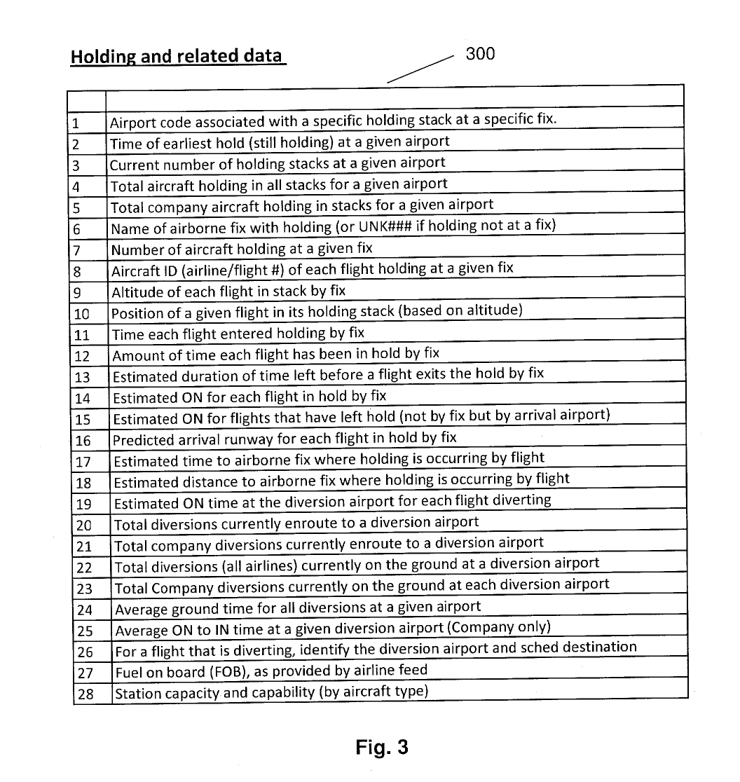

FIG. 3 shows a table 300 that includes examples of categories of data related to holds that may be displayed and uplinked to the flight deck. In this example, there are twenty-eight (28) categories of information that are related to holds. As described above, a user 140-160 or a system administrator may select one or more of these categories of information as the default categories of information to uplink to the flight deck of the aircraft. Those skilled in the art will understand that the table 300 is not meant to be a comprehensive list of all data related to holds, but is only an example of the categories of information available. In addition, if the predictive analysis and alert system 120 has a different functionality than diversion management, then the categories of information may also be different.

Referring back to FIG. 2, the dialog box 230 includes the information Aircraft in hold (same fix) 240 that correlates to entry 7 of the table 300, Position in hold 242 that correlates to entry 10 of the table 300, Expected duration remaining 244 that correlates to the entry 13 of the table 300, Estimated On 246 that correlates to the entry 14 of the table 300 and Holding Fixes (same airport) 248 that correlates to the entry 2 of the table 300. Thus, as can be seen from this example, the user 140-160 or system administrator has selected a subset of five (5) of the categories of information from the table 300 as the default information for the holds that are displayed on the diversion management dialog box 230 to be uplinked to the flight deck of the aircraft. Each user 140-160 may select different categories of information as the default information. For example, the user 140 may be associated with United Airlines and may select a different subset of categories than the user 150 that is associated with Delta Airlines. Meanwhile, the user 160 may be associated with an airport and select a completely different subset of categories of information than the users 140 and 150.

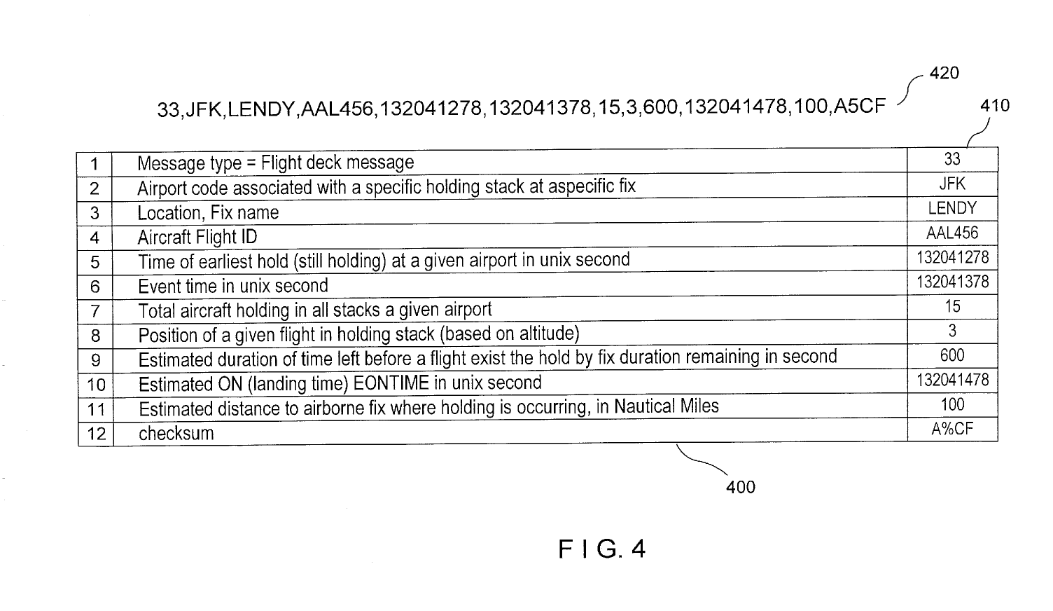

FIG. 4 shows a table 400 that includes an example of a further selection of categories of information to be uplinked to an aircraft. In this example, there are ten (10) categories of information (labeled 2-11 in the table 400) that are selected as the default message, e.g., that will be auto-populated and displayed in the dialog box 230 when a flight is selected. In addition, the table 400 includes the entry 1 which shows the message type associated with a flight deck message and entry 12 that is a checksum transmitted with each message to the flight deck to make sure the complete message has been received at the flight deck.

FIG. 4 also shows in the column 410, examples of information for each of the categories of information. Finally, FIG. 4 also shows an example of a message 420 that will be transmitted to the flight deck of the aircraft based on the example information provided in the column 410. This message 420 assumes that the user 140-160 has not deselected any of the default categories of information in the dialog box 230.

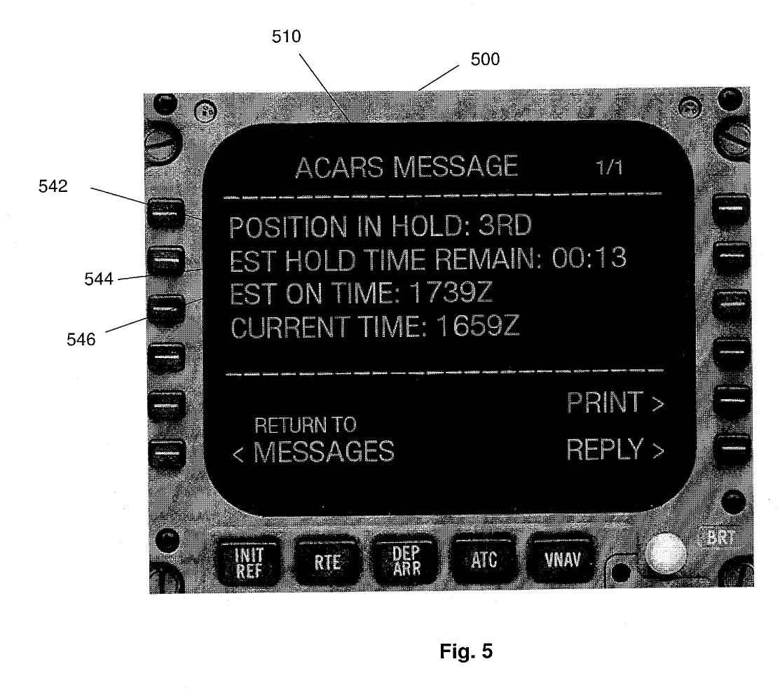

FIG. 5 shows an exemplary flight deck display 500 that is displayed on a display device of the aircraft. The flight deck display 500 is a display in the particular aircraft to which the data is uplinked. In this example, the data displayed on the flight deck display 500 corresponds to the data selected in the dialog box 230 of FIG. 2. Referring back to FIG. 2, the user 140-160 has selected the categories of information Position in hold 242, Expected duration remaining 244, Estimated On 246 to be uplinked to the aircraft. The flight deck display 500 displays the Position in hold 542, Expected duration remaining 544, Estimated On 546 that correspond to these selected categories.

As can be seen from this example, the user 140-160 selected the categories of information and then pressed the send button 235. The corresponding information was formatted into a message (e.g., in the format of FIG. 4) and uplinked to the flight deck of the aircraft. The display device of the aircraft received the message and displayed the corresponding information on the flight deck display 500. Thus, the pilot of the flight now has the predictive analysis and alert information that is also available to the users 140-160 on the ground.

As shown in FIG. 5, the type of message used to transmit the information is an Aircraft Communications Addressing and Reporting System (ACARS) message. An ACARS message is a digital datalink system for transmission of short, relatively simple messages between aircraft and ground stations via radio or satellite. All commercial aircraft are equipped to receive ACARS messages. Thus, the uplinked information may be formatted as an ACARS message and sent to the aircraft. Those skilled in the art will understand that it is not a requirement that the uplinked data be sent via an ACARS message. Other types of data communication from the ground to the aircraft may also be used to transmit the messages. For example, many aircraft are now equipped with Global Position System (GPS) receivers. The messages may be embedded in the signal received from the GPS satellites and received by the GPS receivers.

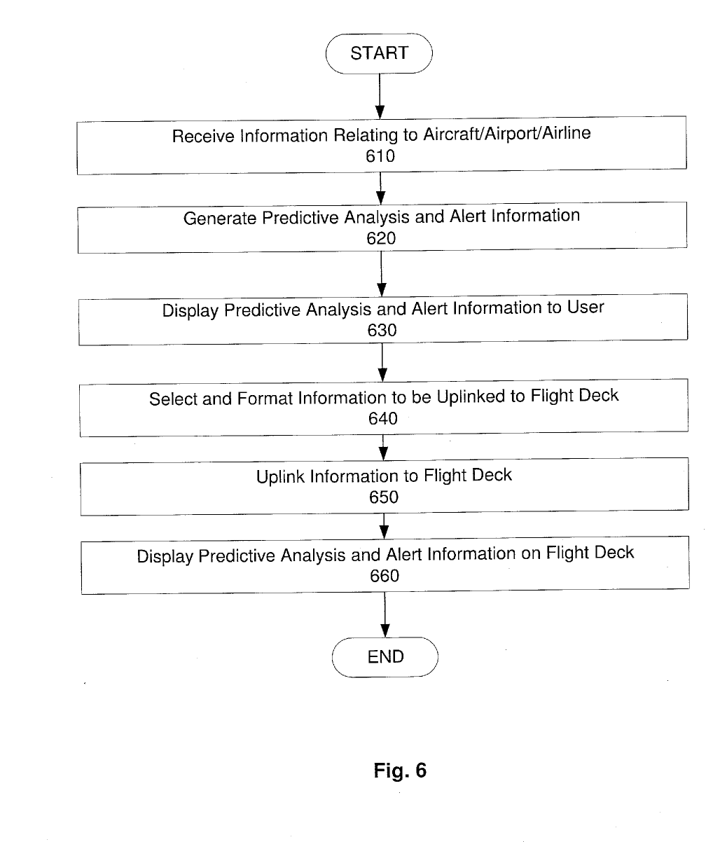

FIG. 6 shows an exemplary method 600 for uplinking data to the flight deck of an aircraft. The exemplary method 600 will be described with reference to the elements of the preceding FIGS. 1-5. In step 610, information related to an airport, aircraft and/or airline is received by, for example, a data feed arrangement 110. In step 620, predictive analysis and alert information is generated by a predictive analysis and alert system 120 based on the information received in step 610.

In step 630, the predictive analysis and alert information is displayed to a user 140-160. In step 640, the user 140-160 selects the categories of information that are to be uplinked to the flight deck of the aircraft, e.g., via a dialog box 230, and the information is formatted for transmission to the aircraft.

In step 650, the selected information is uplinked to the aircraft via, for example, an ACARS message. In step 660, the aircraft receives the message and displays the information on a flight deck display such as flight deck display 500. The result of this message is that the predictive analysis and alert information that is available to the users on the ground is also now available to the pilots of a flight.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Mac platform and MAC OS, etc. In a further example, the exemplary embodiments of the uplink information system may be a program containing lines of code stored on a non-transitory computer readable storage medium that, when compiled, may be executed on a processor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalent.

What is claimed is:

1. A method, comprising:
generating, by a server, predictive analysis and alert information;
displaying the predictive analysis and alert information to a user on the ground;
receiving, from the user, a selection of categories of the predictive analysis and alert information;
formatting a message including the predictive analysis and alert information corresponding to the selected categories; and
transmitting the message to a flight deck of an aircraft.

2. The method of claim 1, further comprising:
displaying the information included in the message on the flight deck of the aircraft.

3. The method of claim 1, wherein the message is an Aircraft Communications Addressing and Reporting System (ACARS) message.

4. The method of claim 1, wherein the predictive analysis and alert information relates to one of diversion management, surface management, tarmac management, departure metering, arrival management and airspace optimization.

5. The method of claim 1, further comprising:
receiving, by the server, one of aircraft information, airport information and airline information, wherein the predictive analysis and alert information is generated based on the one of the aircraft information, airport information and airline information.

6. A system, comprising:
a predictive analysis and alert system that generates predictive analysis and alert information and distributes the predictive analysis and alert information to a user;
a user interface that displays the predictive analysis and alert information plurality and receives, from the user, a selection of categories of the predictive analysis and alert information; and
an uplink module that formats a message including the predictive analysis and alert information corresponding to the selected categories and transmits the message to a flight deck of an aircraft.

7. The system of claim 6, further comprising:
a flight deck display system that receives and displays the information included in the message on the flight deck of the aircraft.

8. The system of claim 6, wherein the message is an Aircraft Communications Addressing and Reporting System (ACARS) message.

9. The system of claim 6, wherein the predictive analysis and alert information relates to one of diversion management, surface management, tarmac management, departure metering, arrival management and airspace optimization.

10. The system of claim 6, further comprising:
a data feed arrangement that receives one of aircraft information, airport information and airline information, and transmits the one of the aircraft information, airport information and airline information to the predictive analysis and alert system, wherein the predictive analysis and alert information is generated based on the one of the aircraft information, airport information and airline information.

11. A non-transitory computer readable storage medium storing a set of instructions that are executable by a processor, to cause the processor to:
generate predictive analysis and alert information;
display the predictive analysis and alert information to a user on the ground;
receive, from the user, a selection of categories of the predictive analysis and alert information;
format a message including the predictive analysis and alert information corresponding to the selected categories; and
transmit the message to a flight deck of an aircraft.

12. The non-transitory computer readable storage medium of claim 11, wherein the message is an Aircraft Communications Addressing and Reporting System (ACARS) message.

13. The non-transitory computer readable storage medium of claim 11, wherein the predictive analysis and alert information relates to one of diversion management, surface management, tarmac management, departure metering, arrival management and airspace optimization.

14. The non-transitory computer readable storage medium of claim 11, wherein the instructions further cause the processor to:
receive one of aircraft information, airport information and airline information, wherein the predictive analysis and alert information is generated based on the one of the aircraft information, airport information and airline information.
